(19) United States
(12) Patent Application Publication
(10) Pub. No.: US 2026/0300691 A1
(43) Pub. Date: Oct. 1, 2026

(54) DISTRIBUTION SYSTEM POWER-FLOW SOLUTION BY HIERARCHICAL ARTIFICIAL NEURAL NETWORKS STRUCTURE

(71) Applicant: RAMOT AT TEL-AVIV UNIVERSITY LTD., Tel Aviv (IL)

(72) Inventors: Arbel YANIV, Petach-Tikva (IL); Yuval BECK, Pardesiya (IL)

(21) Appl. No.: 19/478,275

(22) PCT Filed: Apr. 24, 2024
(86) PCT No.: PCT/IB2024/054011

§ 371 Date: Oct. 24, 2025

Related U.S. Application Data
(60) Provisional application No. 63/499,382, filed on May 1, 2023.

(51) Int. Cl. G06N 3/045

(52) U.S. Cl. CPC G06N 3/045

(57) ABSTRACT

Disclosed herein is a method for solving a power flow problem in at least one system. The method includes dividing, by at least one processor, the system into a plurality of clusters, where each of the plurality of clusters has a modular architecture, constructing, by the at least one processor, a hierarchical artificial neural network (ANN) for each of the plurality of clusters, thereby generating a plurality of ANNs, and determining, by the at least one processor by the plurality of ANNs, at least one solution to a power flow problem for (i) each of the plurality of ANNs, and (2) the hierarchical ANN as a whole, where each of the plurality of ANNs is organized hierarchically such that data from at least one lower-level layer is fed into at least one upper layer in accordance with an electric correlation between at least one cluster in the plurality of clusters.

### CROSS-REFERENCE TO RELATED APPLICATIONS

This application is a National Phase entry of International Application No. PCT/IB2024/054011 under § 371 and is related to and claims priority to U.S. Patent Application No. 63/499,382, filed May 1, 2023, which are incorporated herein by reference in their entireties.

### BACKGROUND

Monitoring, controlling, and supervising conventional power grids has grown in recent years and the conventional power grids have become smart grids. However, conventional methods to monitor, control, and supervise are too slow to allow for control and real-time optimization.

It is with these issues in mind, among others, that various aspects of the disclosure were conceived.

### SUMMARY

The present disclosure is directed to a system and method for solving a power flow problem in at least one distribution system or any type of power system. In addition, the present disclosure is directed to a system and method for solving a power flow problem in at least one power system.

In one example, a method for solving a power flow problem in at least one distribution system or other types of power systems having various sizes may include dividing, by at least one processor, the at least one distribution system or other types of power systems having various sizes into a plurality of clusters, wherein each of the plurality of clusters has a modular architecture with a plurality of modules, constructing, by the at least one processor, a hierarchical artificial neural network (ANN) for each of the plurality of clusters, thereby generating a plurality of ANNs, and determining, by the at least one processor by the plurality of ANNs, at least one solution to a power flow problem for (i) each of the plurality of ANNs, and (2) the hierarchical ANN as a whole, wherein each of the plurality of ANNs is organized hierarchically such that data from at least one lower-level layer is fed into at least one upper layer in accordance with an electric correlation between at least one cluster in the plurality of clusters.

In another example, a method for solving a power flow problem in at least one or distribution system or power system may include dividing, by at least one processor, each of the at least one distribution system or power system into a plurality of clusters, implementing, by the at least one processor, a hierarchical artificial neural network (ANN) for each of the plurality of clusters, thereby generating a plurality of ANNs, organizing, by the at least one processor, the plurality of ANNs according to a hierarchical division based on an algorithm, and determining, by the at least one processor by the plurality of ANNs, at least one solution to a power flow problem for (i) each of the plurality of ANNs, and (2) an entire hierarchical structure of the plurality of ANNs, wherein the plurality of ANNs are configured to predict voltage amplitudes, phases, apparent powers, and correlation preserving parameters of the at least one distribution system or power system, and wherein each of the plurality of ANNs is organized hierarchically such that data from at least one lower-level layer is fed into at least one upper layer in accordance with an electric correlation between at least one cluster in the plurality of clusters.

In another example, a system for solving a power flow problem in at least one distribution system or other types of power systems having various sizes may include a memory storing computer-readable instructions and at least one processor to execute the instructions to divide the at least one distribution system or other types of power systems having various sizes into a plurality of clusters, wherein each of the plurality of clusters has a modular architecture with a plurality of modules, construct a hierarchical artificial neural network (ANN) for each of the plurality of clusters, thereby generating a plurality of ANNs, and determine at least one solution to a power flow problem for (i) each of the plurality of ANNs, and (2) the hierarchical ANN as a whole, wherein each of the plurality of ANNs is organized hierarchically such that data from at least one lower-level layer is fed into at least one upper layer in accordance with an electric correlation between at least one cluster in the plurality of clusters.

In another example, a system for solving a power flow problem in at least one distribution or power system may include a memory storing computer-readable instructions and at least one processor to execute the instructions to divide each of the at least one distribution or power system into a plurality of clusters, implement a hierarchical artificial neural network (ANN) for each of the plurality of clusters, thereby generating a plurality of ANNs, organize the plurality of ANNs according to a hierarchical division based on an algorithm, and determine by the plurality of ANNs at least one solution to a power flow problem for (i) each of the plurality of ANNs, and (2) an entire hierarchical structure of the plurality of ANNs, wherein the plurality of ANNs are configured to predict voltage amplitudes, phases, apparent powers, and correlation preserving parameters of the at least one distribution or power system, and wherein each of the plurality of ANNs is organized hierarchically such that data from at least one lower-level layer is fed into at least one upper layer in accordance with an electric correlation between at least one cluster in the plurality of clusters.

In another example, a non-transitory computer-readable storage medium includes instructions stored thereon that, when executed by at least one computing device cause the at least one computing device to perform operations for solving a power flow problem in at least one distribution system or other types of power systems having various sizes, the operations including dividing the at least one distribution system or other types of power systems having various sizes into a plurality of clusters, wherein each of the plurality of clusters has a modular architecture with a plurality of modules, constructing a hierarchical artificial neural network (ANN) for each of the plurality of clusters, thereby generating a plurality of ANNs, and determining by the plurality of ANNs at least one solution to a power flow problem for (i) each of the plurality of ANNs, and (2) the hierarchical ANN as a whole, wherein each of the plurality of ANNs is organized hierarchically such that data from at least one lower-level layer is fed into at least one upper layer in accordance with an electric correlation between at least one cluster in the plurality of clusters.

In another example, a non-transitory computer-readable storage medium includes instructions stored thereon that, when executed by at least one computing device cause the at least one computing device to perform operations for solving a power flow problem in at least one distribution system or power system, the operations including dividing each of the at least one distribution system or power system into a plurality of clusters, implementing a hierarchical artificial neural network (ANN) for each of the plurality of clusters, thereby generating a plurality of ANNs, organizing the plurality of ANNs according to a hierarchical division based on an algorithm, and determining by the plurality of ANNs at least one solution to a power flow problem for (i) each of the plurality of ANNs, and (2) an entire hierarchical structure of the plurality of ANNs, wherein the plurality of ANNs are configured to predict voltage amplitudes, phases, apparent powers, and correlation preserving parameters of the at least one distribution system or power system, and wherein each of the plurality of ANNs is organized hierarchically such that data from at least one lower-level layer is fed into at least one upper layer in accordance with an electric correlation between at least one cluster in the plurality of clusters.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an example schematic of an ANN parameters allocation methodology of a power flow system according to an example of the instant disclosure.

FIG. 2 shows an example schematic of an ANNs hierarchical array structure of the power flow system according to an example of the instant disclosure.

FIG. 3 shows an example fully connected feedforward multilayer perceptron of the power flow system according to an example of the instant disclosure.

FIG. 4 illustrates an example schematic topology of IEEE-123 divided according to the InfoMap algorithm according to an example of the instant disclosure.

FIG. 5 shows an example schematic topology of EPRI Ckt5 divided according to the InfoMap algorithm according to an example of the instant disclosure.

FIG. 6 shows an example schematic of the ANN's array structure implementation for EPRI CKt5 according to an example of the instant disclosure.

FIG. 7 illustrates an example of voltage amplitude of numeric results (NR) calculated via OpenDSS versus those predicted with the ANN of cluster A of IEEE-123 according to an example of the instant disclosure.

FIG. 8 shows an example of voltage phase A of numeric results (NR) calculated via OpenDSS versus those predicted with the ANN of cluster A of IEEE-123 according to an example of the instant disclosure.

FIG. 9 shows an example of voltage phase B of numeric results (NR) calculated via OpenDSS versus those predicted with the ANN of cluster A of IEEE-123 according to an example of the instant disclosure.

FIG. 10 shows an example of voltage phase C of numeric results (NR) calculated via OpenDSS versus those predicted with the ANN of cluster A of IEEE-123 according to an example of the instant disclosure.

FIG. 11 shows an example of apparent power of numeric results (NR) calculated via OpenDSS versus those predicted with the ANN of cluster A of IEEE-123 according to an example of the instant disclosure.

FIG. 12 shows a method of solving a power flow problem in at least one distribution system or other types of power systems having various sizes, according to an example of the instant disclosure.

FIG. 13 shows a method of solving a power flow problem in at least one distribution or power system according to an example of the instant disclosure.

FIG. 14 shows an example of a system for implementing certain aspects of the present technology.

### DETAILED DESCRIPTION

The present disclosure is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present disclosure, as the disclosure encompasses other embodiments not specifically recited in this description, including alternatives, modifications, and equivalents within the spirit and scope of the disclosure. Further, the use of the terms “invention,” “present invention,” “embodiment,” and similar terms throughout the description are used broadly and not intended to mean that any embodiment of the invention requires, or is limited to, any particular aspect being described or that such description is the only manner in which the invention may be made or used. Additionally, the disclosure may be described in the context of specific applications; however, embodiments of the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the disclosure. Thus, it is apparent that embodiments of the present invention can be carried out in a variety of ways, and does not require any of the specific features described herein. Also, well-known functions or constructions are not described in detail since they would obscure the disclosure with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

A new method and system for solving the power flow problem in distribution systems which is fast, parallel, as well as modular, straightforward, simplified and generic is disclosed. This approach is based on a hierarchical construction of an ANNs tree. The power system is divided into multiple clusters, with a modular architecture. For each cluster an ANN is constructed, where the ANNs of the different clusters are organized in a hierarchical manner, in which the data from a lower-level layer is fed into an upper layer in accordance with the electric correlation between the clusters. The solution time is fast as it is based on the neural networks predictions and also enables parallel computing of all clusters in any given layer. The various clusters have a uniform designed single-hidden-layer ANNs, thus providing a robust and novel architectural implementation. The disclosed methodology is an important milestone for bypassing power flow classical methods and introducing a novel machine learning based approach. The solution for a three-phase unbalance IEEE-123 system as well as an EPRI Ckt5 system are presented. The predictions of the ANNs of the hierarchical structures are compared to the solution as calculated by OpenDSS simulation software, with very promising results.

The integration of technologies of monitoring, controlling, and supervision into conventional power grids has been accelerated in recent years, thus transforming them into smart grids. The problem of solving the state of a grid is called “Power-Flow”, and it consists of a system of 2(n−1) non-linear equations, where n is the number of nodes. A typical distribution system can have thousands of nodes and this set of non-linear equations must be solved numerically. For control and optimization applications, one needs to solve the power flow (PF) problem many times, as the search space of possible configurations is very large.

As a result, for real-time control and optimization purposes, the solution time of the power flow problem is a critical factor. Classical numerical solution methods such as Newton-Raphson (NR), Gauss-Seidel, and their derivatives, or sequential Forward Backward Sweep (FBS) algorithm, which may be suitable for three phase unbalanced distribution systems, and a modified unsequential scheme has been developed. However, all of the above-mentioned methods are too slow for control and real time optimization applications.

The other limitation of such numerical methods is their dependency on the parameters' data, which is often not fully available. For example, in order to solve the PF set of equations, the admittance matrix must be known. However, often, the line data in distribution systems is only partially known.

Both of the above mentioned limitations can be mitigated using ML approaches: the training of neural networks on historical data measurements eliminates the need of the parameters' data, and while the training stage can be long, once it is done, ANNs yield very fast predictions in comparison to numerical approaches.

Neural networks are used for various purposes in the context of power systems, among them is to solve the power flow problem. A work of ML for power system operation support as in, includes a preliminary study of testing deep neural networks for approximating load-flow of Matpower 30 and 118-bus grids via Tensorflow framework. There are physics-guided neural networks. Inspired by unsupervised and supervised auto-encoders, a framework of neural networks that simultaneously model PF solvers and rebuilds the PF model is suggested. However, the suggested model is restricted as it requires accurate topology information.

Deep neural networks, such as the above-mentioned ones, may be effective for Euclidean data, but are not suitable for processing graph-structured data, such as the power flow problem, as it may be irregular in comparison to Euclidean data.

Since power systems can be represented as graphs and there is a correlation between its various components, an advantage of the topology of the power system should be taken, especially for distribution systems which are characterized by frequent topology changes.

A family of neural networks can be represented as a graph and contain relations between its elements using graph neural networks (GNNs). GNNs capture the dependence in graphs via the distributed computing theory synchronous message passing system. This family preserves a state that represents information from its neighborhood with arbitrary depth. However, this system is very inefficient for large graphs when messages need to travel across long distances.

GNNs can have several uses in the context of power systems, such as for parameter and state estimations. Also, a learning model that utilizes the structure of the power grid is proposed. It may also be useful for power flow and optimal power flow. However, this model is limited only for power grids where all lines have the same physical characteristics. Another variation of this approach is graph convolutional neural network (GCN). This generic and data-driven approach can approximate the load flow calculations by learning the loading on each line instead of the actual voltages. An unsupervised graph neural solver was implemented, which calculates power flow by minimizing the violation of Kirchhoff's law at each bus.

Graph theory is also used for power flow calculations. There, the proposed methods are limited only to three-phase balanced distribution systems. A graph theory based PF algorithm for active electrical DSs based on modelling via incidence matrices, which may be able to handle meshed topologies and unbalanced networks, is possible.

A dynamic graph-based method for the application of the planning problem, which was implemented on the 69-bus IEEE bus distribution test system, may be able to use the topological structure of the system as well as reduce the search space. However, the classical power flow solution method is still a bottleneck for the computational time in comparison to neural network implementations, as demonstrated in many works.

In real-world applications, complex and large problems can often be divided into sub-problems for simplification. One such problem is the classification task, which is generally a multi-class problem. There, every neural network is assigned with a task of solving independently one of these sub-problems.

A study which proposes a hierarchical parallel dynamic estimation algorithm is known and is implemented on IEEE-30 and IEEE-118. The computational burden can be reduced as each processor uses state matrix of smaller dimension. Since it is possible that there is no need for any information exchange from the central to the low level processors, the communication requirements might also be reduced. It can be considered that parallel calculation of clusters that do not feed each other and there is no solution by ANNs.

Another hierarchical dynamic state estimation in power systems was implemented with ANN-based dynamic load prediction on IEEE-118 feeder. The dynamics of the power system were modeled using ANN-based bus-load prediction and power flow for state prediction. At the filtering step, a hierarchical model which incorporates the measurement function non-linearities was used. This could reduce the computational effort, and might be more suitable for on-line application. However, both are used for state estimation, which happens prior to the power flow solution described herein.

Another approach for a scaled solution of unbalanced distribution system (DS) uses relaxed sub-problems of low complexity. Such an algorithm is based on the relaxation of the non-linear set of equations as conic constraints with directional constraints over multiple iterations of a second order cone programming (SOCP).

In this disclosure, the PF problem is solved by dividing the distribution system into clusters. The division is done using the InfoMap algorithm. These clusters are organized in a hierarchical structure. Each cluster is implemented by a designated ANN in such a way that each layer of ANNs feeds on its results for the active and reactive powers to the upper layer of ANNs as an input. Once the system is divided by the InfoMap algorithm, each cluster is solved by a separate single-hidden-layer neural network with a uniform design. As Infomap is a multi-level algorithm, it provides a wide variety of possible partition schemes, out of which it is possible to choose a partition of the original graph representing the distribution system according to the architecture and performance objectives.

This disclosure shows the theory of the proposed method as well as full simulation examples on the unbalanced IEEE-123 and EPRI Ckt5 distribution networks. The results are shown to have a MAE of up to 1.2%, and the computational time is substantially reduced by at least a magnitude of order in comparison to the solution by the numerical method as simulated with OpenDSS which is an open-source program that solves unbalanced distribution systems by the fixed-point iteration method.

Two contributions of the disclosure are: 1. Hierarchical structure of ANNs, which is inherently modular and constructed by simplified sub problems of the complete DS topology 2. This hierarchical structure of neural networks and layer-wise parallel computing yields fast prediction in comparison to classical numerical methods. The novel sub-problems ML orchestrate approach of a solver to the PF problem is purely data-driven, namely, there is no need to know any of the underlying physical topology of the power system. In comparison to other approaches of ANNs-based implementations for the solution of the PF problem in DSs, which are characterized by complex architectures as a result of the characteristics of such real power systems, after applying the division algorithm, the utilization of simple, generic, and unified design single-hidden-layer neural networks is possible via the hierarchical tree of ANNs' construction, in accordance to the clusters of the complete power system and the relations between them. This structure is also inherently modular, which is an important advantage as one of the limitations of existing neural network implementations is their limited compatibility to the dynamic nature of DSs, which can have numerous switching events often causing topology changes in a single day due to scheduled maintenance, faults, and high penetration of renewable energy resources.

### Classical Numerical Power Flow Solution of Distribution Grids

The PF problem is a nonlinear set of 2n equations, where n is the number of nodes of the power system.

Balanced three-phase systems are characterized by a nodal admittance matrix Y, which expresses the relations between node voltages V and currents I, as follows:

$${I}_{i} = {\sum }_{j = 1}^{n} {Y}_{i , j} {V}_{j} i = 1 , … , n \qquad ( 1 )$$

Taking the conjugate on both sides of (1), multiplying both sides by the nodal voltage Vᵢ, and using the apparent power formula,

$${S}_{i} = {V}_{i} {I}_{i}^{*}$$

results in:

$${S}_{i} = {P}_{i} + {jQ}_{i} = {\sum }_{j = 1}^{n} {V}_{i} {V}_{j}^{*} {Y}_{i , j}^{*} i = 1 , … , n \qquad ( 2 )$$

The active power, Pᵢ, and reactive power, Qᵢ, can be derived from (2) by separating the apparent power, S, into real and imaginary components as follows:

$$\begin{matrix}{P}_{i} = Re \{ {\sum }_{j = 1}^{n} {V}_{i} {V}_{j}^{*} {Y}_{i , j}^{*} \} ∀ i = 1 , … , n \\ {Q}_{i} = Im \{ {\sum }_{j = 1}^{n} {V}_{i} {V}_{j}^{*} {Y}_{i , j}^{*} \} ∀ i = 1 , … , n\end{matrix} \} \qquad ( 3 )$$

As the PF set of equations is nonlinear, numerical methods are classically used as a solution method. These equations are for the balanced case which is suitable for parts of Europe and Asia. In other countries like most of the United States, DSs are unbalanced in nature. Therefore, to solve the PF problem, these equations should be extended for the unbalanced case that includes three sets of equations:

$${I}_{i}^{abc} = {\sum }_{j = 1}^{n} {Y}_{i , j}^{abc} {V}_{j}^{abc} i = 1 , … , n \qquad ( 4 )$$

$$where {I}_{i}^{abc} = [ \begin{matrix}\begin{matrix}{I}_{i}^{a} \\ {I}_{i}^{b}\end{matrix} \\ {I}_{i}^{c}\end{matrix} ] , {V}_{j}^{abc} = [ \begin{matrix}\begin{matrix}{V}_{j}^{a} \\ {V}_{j}^{b}\end{matrix} \\ {V}_{j}^{c}\end{matrix} ] , {Y}_{i , j}^{abc} = [ \begin{matrix}{Y}_{i , j}^{aa} & {Y}_{i , j}^{ab} & {Y}_{i , j}^{ac} \\ {Y}_{i , j}^{ba} & {Y}_{i , j}^{bb} & {Y}_{i , j}^{bc} \\ {Y}_{i , j}^{ca} & {Y}_{i , j}^{cb} & {Y}_{i , j}^{cc}\end{matrix} ] \qquad ( 5 )$$

where

$${I}_{i}^{p}$$

is the injected current,

$${V}_{i}^{p}$$

is the complex voltage at bus i for phase p, and

$${Y}_{i , j}^{{pp}^{′}}$$

is the element of the admittance matrix connecting buses i, j for phase p, p′. Following (4) and
(5), the injected current lᵢ^{p} is as follows:

$${I}_{i}^{p} = {\sum }_{j = 1}^{n} {\sum }_{q = a , b , c} {Y}_{i , j}^{pq} {V}_{j}^{q} i = 1 , … , n \qquad ( 6 )$$

and the three-phase power flow equations for the unbalanced case are:

$${S}_{i}^{p} = {V}_{p} {\sum }_{j = 1}^{n} {\sum }_{q = a , b , c} {( {V}_{j}^{{p}^{′}} )}^{*} {( {Y}_{i , j}^{{pp}^{′}} )}^{*} i = 1 , … , n \qquad ( 7 )$$

Where Sᵢ^{p} is the injected complex power at bus i for phase p. Alternatively, it is possible to use methods based on symmetrical components. A PF simulation software that have gained a lot of interest and is used for various applications is OpenDSS, which is based on a fixed-point iterative method. OpenDSS is an open source software for DS simulations, which is also suitable for unbalanced systems. It is commonly used as a source for comparison, both for verification as well as for computational comparison purposes for the state-of-the-art solutions in this field. The numerical solutions from OpenDSS simulation software are used in this disclosure as ground truth for the training and the predictions' errors evaluation of each of the ANNs in the ANNs' array structure.

### The Proposed Hierarchical Structure

At least one example of the disclosure solves the PF problem for DSs using at least one hierarchical ANN, namely by dividing it into clusters where each cluster may include a similar number of nodes. The network division into clusters is presented using a community detection algorithm as is shown herein. The conventional PF solver of OpenDSS is used for generating the data for training and testing the ANNs. Therefore, the process of attaining all the data which might take time is only for the training stage and is not counted at the testing stage. In at least a further example, an alternative way of attaining the data is used, specifically, using historic measured data instead of using a PF program.

### ANN Array Structure Implementation

As the architecture design for a neural network of a distribution power system is a very complicated task due to the large number of nodes in real systems and the complex relations between them, the power system is divided into multiple clusters of the same order of size. As each cluster is considerably smaller than the complete system, a simple fully-connected neural network (FCNN) can be implemented for each cluster with a uniform choice of hyper-parameters as detailed below herein. The ANNs for the different clusters were organized according to the hierarchical division by Infomap algorithm.

Each ANN is trained and tested with different training and testing sets according to its specific nodes and loads.

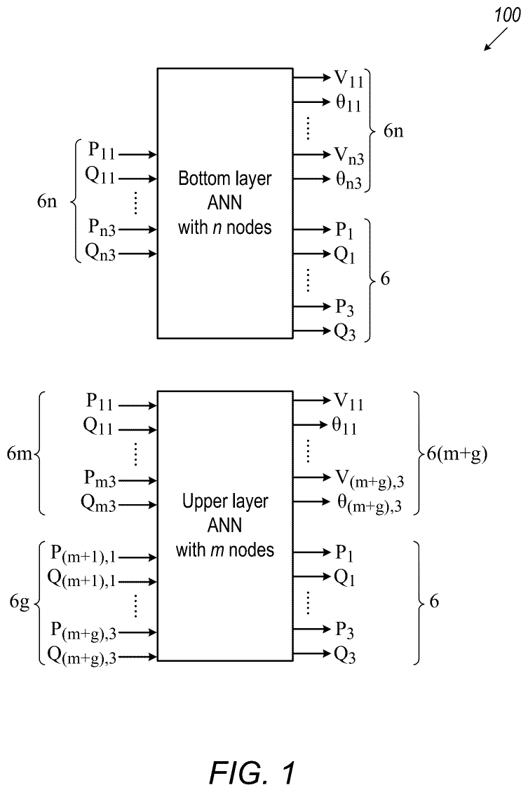

Then, each ANN yields the predictions of the voltage amplitudes, phases and correlation preserving parameters. These parameters include the data that needs to be forwarded to the ANNs on the layer above it. This data includes the active and reactive powers at the PCC (point of common coupling) between the layers. The above procedure excludes the top ANN at layer zero as seen in FIG. 1 which do not pass on any information due to its location.

FIG. 1 shows an example schematic 100 of an ANN parameters allocation methodology of a power flow system according to an example of the instant disclosure.

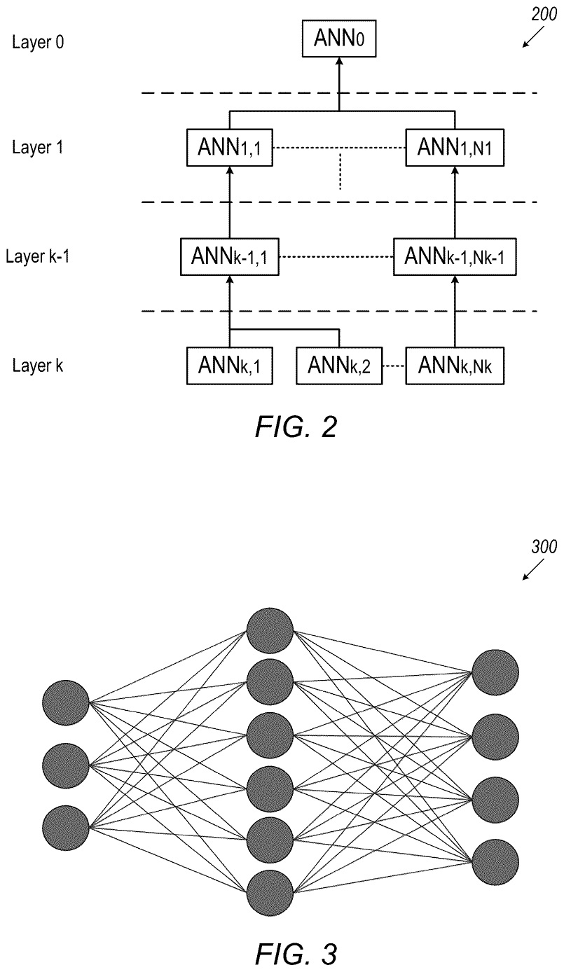

FIG. 2 shows an example schematic 200 of an ANNs hierarchical array structure of the power flow system according to an example of the instant disclosure.

FIG. 3 shows an example fully connected feedforward multilayer perceptron 300 of the power flow system according to an example of the instant disclosure.

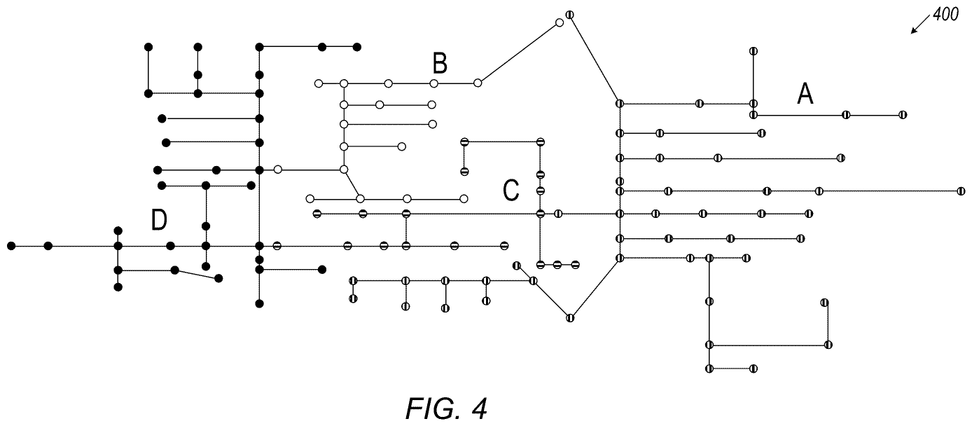

FIG. 4 illustrates an example schematic topology 400 of IEEE-123 divided according to the InfoMap algorithm according to an example of the instant disclosure.

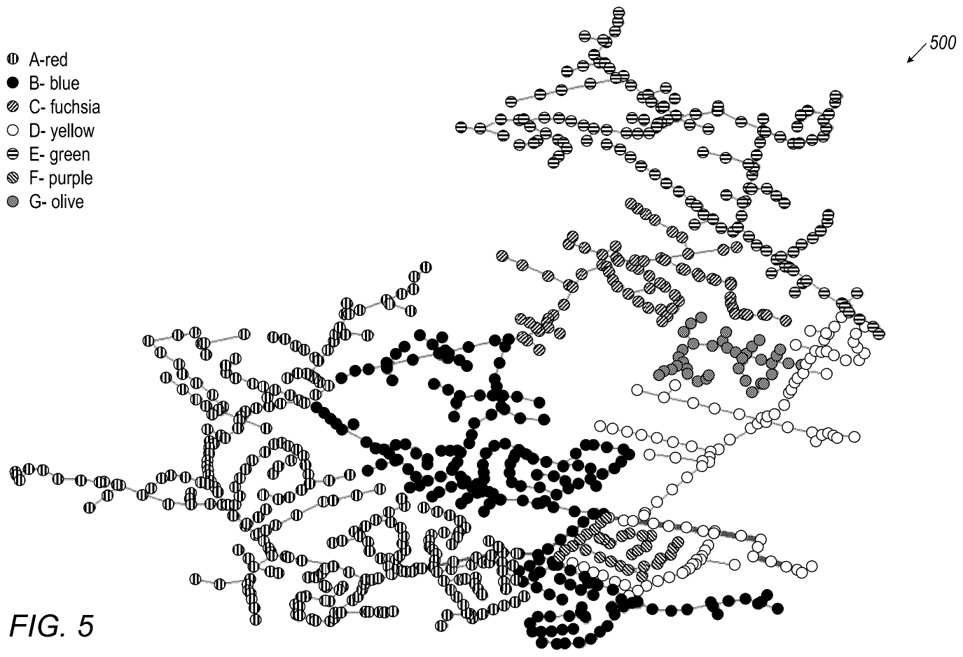

FIG. 5 shows an example schematic topology 500 of EPRI Ckt5 divided according to the InfoMap algorithm according to an example of the instant disclosure.

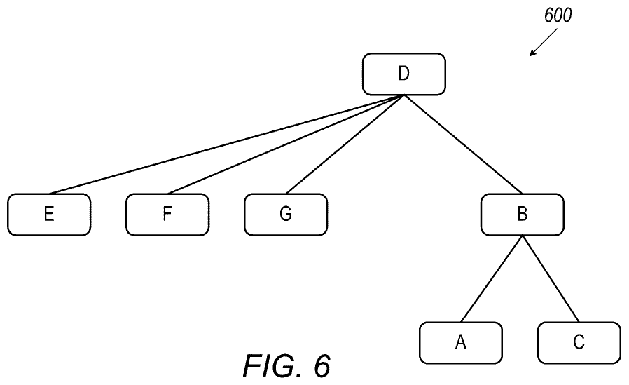

FIG. 6 shows an example schematic 600 of the ANN's array structure implementation for EPRI CKt5 according to an example of the instant disclosure.

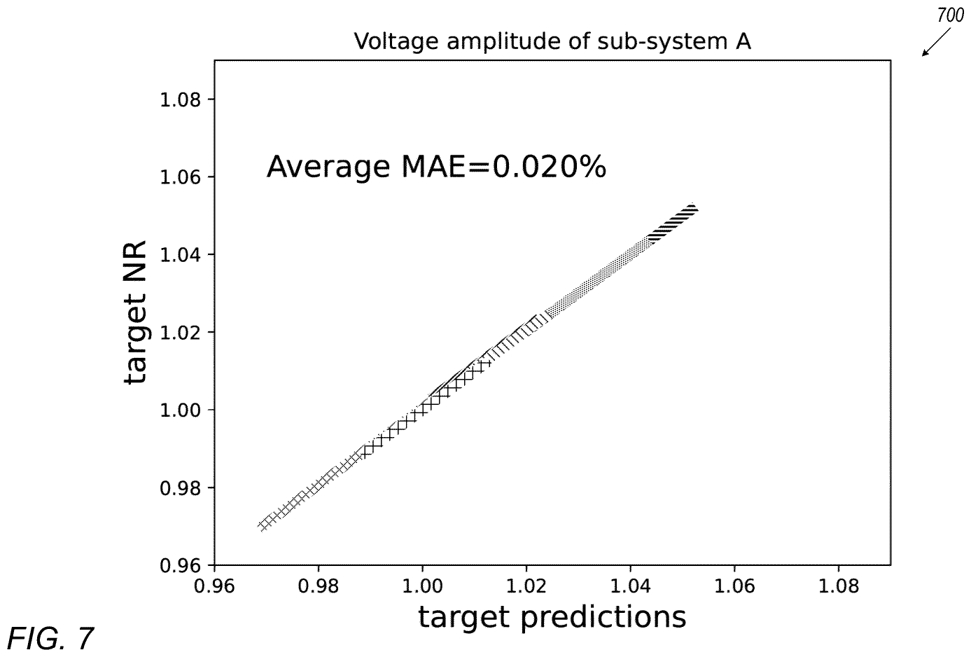

FIG. 7 illustrates an example of voltage amplitude of numeric results (NR) 700 calculated via OpenDSS versus those predicted with the ANN of cluster A of IEEE-123 according to an example of the instant disclosure.

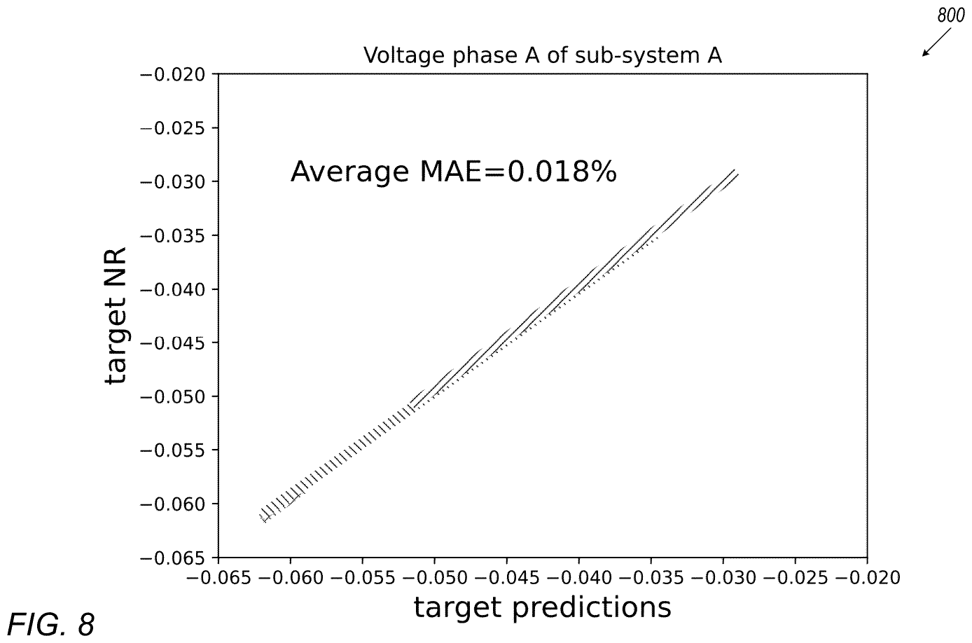

FIG. 8 shows an example of voltage phase A of numeric results (NR) 800 calculated via OpenDSS versus those predicted with the ANN of cluster A of IEEE-123 according to an example of the instant disclosure.

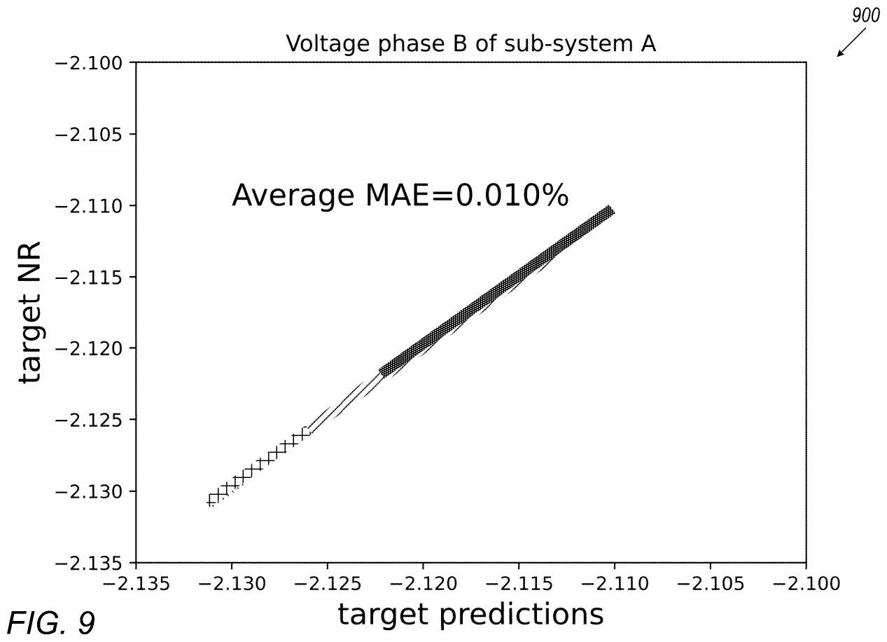

FIG. 9 shows an example of voltage phase B of numeric results (NR) 900 calculated via OpenDSS versus those predicted with the ANN of cluster A of IEEE-123 according to an example of the instant disclosure.

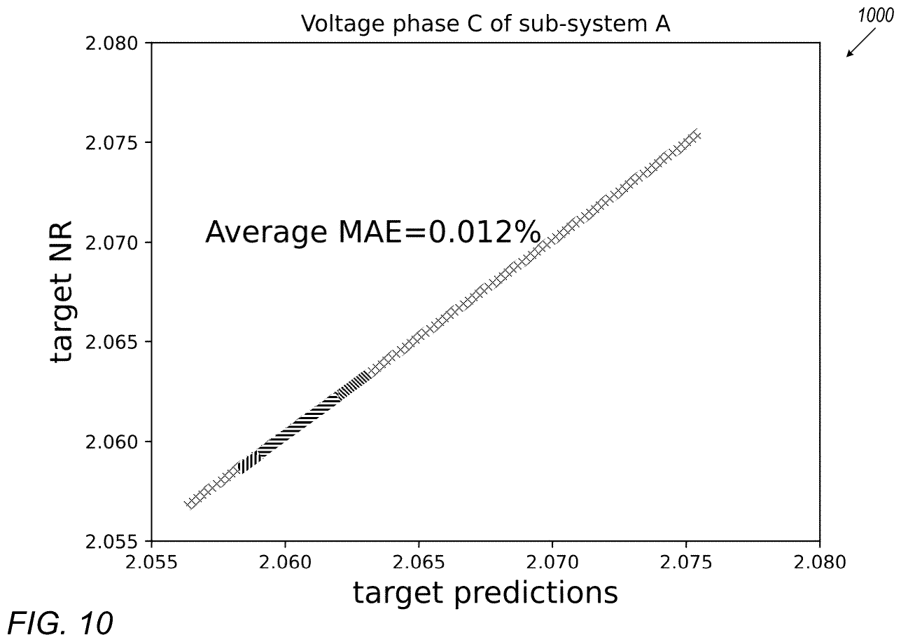

FIG. 10 shows an example of voltage phase C of numeric results (NR) 1000 calculated via OpenDSS versus those predicted with the ANN of cluster A of IEEE-123 according to an example of the instant disclosure.

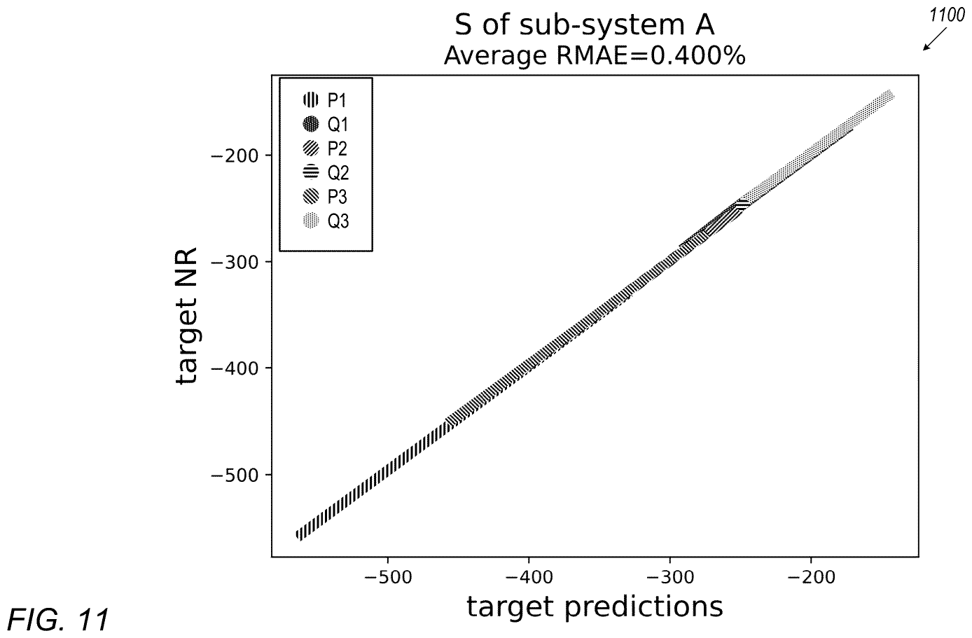

FIG. 11 shows an example of apparent power of numeric results (NR) 1100 calculated via OpenDSS versus those predicted with the ANN of cluster A of IEEE-123 according to an example of the instant disclosure.

In a hierarchical array of ANNs methodology, there is a combination of the parameters included in an ANN designed for a complete power system, and additional parameters which preserve the electrical dependence between the different clusters. The inputs of an ANN for the complete power system are active and reactive powers at each of the loads, as it has only P-Q buses (load buses), and the outputs are the amplitude and phase of the voltage at each of the system's nodes. The additional parameters for a hierarchical ANNs structure are extra inputs or outputs or both according to the location of the cluster in the hierarchy which is dictated according to the partition by the Infomap division algorithm. There are six correlation preserving parameters as inputs/outputs/both (according to the location of the cluster in the hierarchy), namely, injected active and reactive powers (for each connecting node i there will be P_{i,1}, P_{i,2}, P_{i,3}—the three active powers for each phase and Q_{i,1}, Q_{i,2}, Q_{i,3}—the three reactive powers for each of the phases).

The criteria for the additional correlation preserving parameters are as follows. Each cluster which has no clusters beneath it in the feeder (leaf), has additional output parameters of the active and reactive power which flows into the head node of that cluster (at each phase). These output parameters are then passed as input parameters to all of the ANNs which belongs to the clusters which are at the next higher layer, thus preserving the correlation of all of the leaf clusters to the cluster above it (its parent). Note that the correlation preserving parameters which pass from one ANN to another at the ANN testing stage are all the solutions as predicted by the relevant ANN. In the same manner, clusters at a mid-layer have output parameters of the active and reactive power which flows into the common coupling node (CCN) of that cluster (at each phase), and additional input parameters from the cluster below it (from each of its children). This means that, in case a cluster has multiple clusters below it, it will have additional input parameters for each of the CCNs of the clusters below it (child). The only cluster with no additional output parameters is the cluster at the top of the DS (with the head node which is the slack bus of the entire system), as it does not pass any information as there are no clusters above it. This cluster has only additional input parameters of the active and reactive power which flows into the CCN of each of the clusters below it.

The above mentioned parameters allocation methodology is demonstrated in FIG. 1: As can be seen, there is a slight difference if the ANN is a bottom layer ANN or an upper layer, due to the fact that bottom layers ANN are not fed with data from lower levels. Therefore, for a bottom layer cluster with n nodes, three sets of active and reactive powers will be the input of the cluster, namely, a total of 6n inputs. ANNs at upper layers have an inherent feed from a lower layer. For a cluster with m+g nodes, where m is the number of independent nodes and g is the number of nodes that are fed from the lower layer, there will be 6 m independent inputs and 6 g inputs that are fed from the lower level. The minimum value of g is one, and for this case there will be only six inputs (three sets of active and reactive power for each phase). The output data will be the voltage amplitudes and angles at all m+g nodes. Both for bottom layer as well as for upper layer clusters (excluding the cluster at the top level which does not feed forward on any information), there are additional six correlation persevering output parameters of the head node of the cluster that will be used to feed the upper-level cluster as explained above. A schematic of an ANNs hierarchical array structure is shown in FIG. 2. It can be seen that the hierarchy is divided into layers (k+1 layers in the figure). The head bus is included with the upper ANN at layer 0 which may include a single ANN. This ANN will be the last one to be calculated and will be fed by the data of the loads included in that cluster and the data that is fed to this ANN from lower levels. Layer 1 may have M₁ ANNs, layer 2 may have N₂ ANNs, and layer k may have Nₖ ANNs accordingly.

### Community Detection Algorithm-InfoMap

As mentioned above herein, the algorithm for dividing the DS into clusters can be a community detection algorithm or other graph partitioning algorithm.

The goal in community detection for power systems, where the objective is to learn how a network's structure influences the system's behavior, is to find the modular structure of the network with respect to flow of resources. This can be done by exploiting the inference-compression duality.

According to the statistical minimum description length (MDL) principle, any set of data can be represented by a string of symbols from a finite alphabet, since any regularity in a set can be used to compress it. Hence, this principle can be used to find structures that are significant with respect to how resources flow through networks. This also implies that there is a duality between inference to compression of networks. This flow can be found according to a communication process in which a sender wants to communicate to a receiver regarding its trajectory. Thus, the trace of the network's flow is represented by a compressed message.

Shannon's source coding theorems from information theory defines the limits on possible extant a data can be compressed. Data on actual trajectories of resources could be given directly in some problems, or, it could be approximated by the characterization of the network's structure, according to the likely trajectories as random walks (sender) guided by the directed and weighted links of the network. To effectively describe the location of the sender, one needs to effectively assign codewords (encode) to nodes with respect to the dynamics on the network. Sequences of successive steps are critical for the description of flow.

Many real-world networks are structured into a set of regions such that once a random walker enters a region, it tends to stay there for a long time, and movements between regions are relatively rare. For the description of succession of locations this regional structure could be of use. Regions with long persistence time can be assigned with a separate codebook. These regions are called “modules” and their codebooks “module codebooks”. However, allowing reuse of words means that for each entry to a new module, both sender and receiver can simultaneously switch to the correct module codebook, according to an index codebook, specifying the module codebook to be used. The codeword lengths in the index codebook are derived from the relative rates at which a random walker enters each module, while the codeword lengths for each module codebook are derived from the relative rates at which a random walker visits each node in the module or exits the module. Using multiple codebooks, the problem of minimizing the description length is transformed into the problem of finding the best partition of the network with respect to flow. For module partition M of n nodes α=1, 2, . . . n into m modules i=1, 2, . . . , m, the lower bound on code length is denoted as L (M). For an arbitrary partition, L is a weightining by the rate of the use of the codebooks of the frequency-weighted average length of codewords in the index codebook H (Q) plus the frequency-weighted sum of

$$H ( {p}^{i} )$$

which is the average length of codewords in module codebook i:

$$L ( M ) = \text{?} H ( Q ) + {\sum }_{i = 1}^{m} \text{?} H ( {p}^{i} ) \qquad ( 8 )$$

Where

$$H ( X ) = - {\sum }_{1}^{n} {p}_{i} log ( {p}_{i} )$$

is a lower bound on the average length of the codewords for each codebook given by the entropy of a random variable X according to Shannon's source coding theorem for X that occur with frequencies pᵢ for n states which are described by n codewords; [symbol] is the probability to exit module i;

$$q = {\sum }_{i = 1}^{m} \text{?}$$

is the index codebook rate of use, which is the probability that the random walker switches modules any given step; p_{α} is the probability to visit node α;

$${p}_{u}^{i} = {\sum }_{αϵ i} {p}_{α} + \text{?}$$

is the use rate of module codebook i which is the fraction of time the random walk spends in module i plus the probability that it exits the module and the exit message is used. Now, the entropies can be [symbol] is and p_{α}.

The InfoMap algorithm can be used for the network division and is based on a hierarchical version of the map equation. The map equation is a flow-based method, which is based on information theory's Shannon's source coding theorems. The map equation is a lower bound on the average code length given a partition structure. The code describes the movement of a random walker on the network which is a proxy for the flow in it. This theoretical limit defines how efficient (short) the optimal (minimal length) code would be for any given partition, without actually formulating the code. Thus, in order to find the optimal partition of the network, the objective is to minimize the map equation over different possible partitions.

A hierarchical partitioning version of the map equation may include two major differences. First, in order to find an optimal hierarchical partitioning, as sometimes movements between modules can be further compressed by adding one or more coarser index codebooks and movements within modules can be further compressed by adding one or more finer index codebooks, the algorithm recursively tries to add extra index codebooks at coarser and finer levels.

Second, the algorithm can better detect less-separated modules or submodules, as it measures also the description length of steps associated with random teleportation, on top of measuring the description length of steps following links. This way, the small cohesive effect of random teleportation is reduced.

The core of Infomap algorithm is based on the Louvain method: neighboring nodes are joined into modules, which subsequently are joined into supermodules and so on. The hierarchical rebuilding of the network is repeated until the map equation cannot be reduced further. Built upon that core, Infomap generalizes this search algorithm of the two-level map equation into a multilevel algorithm by a recursive search which operates on a module at any level, where for every split of a module into submodules, the two-level search algorithm is used.

Infomap may be used specifically for power grid hierarchical segmentation, and for guided machine learning (ML) for power grid segmentation.

The multilevel characteristic of Infomap makes it specifically suitable for the hereby proposed approach of array of ANNs, as it is possible to choose the granularity of the partition. In case the first level partition is highly unbalanced, it is possible to continue to the second level partition of the sub-modules, and continue even farther for next level partitions as desired.

Therefore, at least one example of the present disclosure uses the hierarchical community detection algorithm InfoMap.

### ANN Unit Topology for Each Cluster

A common learning architecture is the multi-layer perceptron (MLP) artificial neural network (ANN). In this finite directed acyclic graph which can be organized in layers, nodes that are no target of any connection are called input neurons, nodes that are no source of any connection are called out-put neurons, and all of the remaining nodes are called hidden neurons as shown in FIG. 3. Using historical measurements or synthetic databases, such ANNs can be trained in a supervised manner by a training stage where the outputs are given as a part of the database, to approximate the function describing the relation between the inputs and the outputs of the ANN. In the power flow set of equations, the inputs and outputs are the known and unknown electrical parameters respectively. As elaborated in the previous section, in the proposed methodology the power system is divided into clusters and an ANN is assigned to each cluster. Thus, the hyperparameters' selection process for the ANNs assigned to the clusters is elaborated next.

### Model's Hyperparameters

Uniform design characteristics were implemented for each of the ANNs for each of the clusters. The ANNs were chosen to be multi-layer perceptron regressors (MLPRs) with a single hidden layer according to the universal approximation theorem. According to the theorem, a single hidden layer standard multilayer feed-forward network with a finite number of hidden neurons, is a universal approximator among continuous functions on compact subsets of Rn, under mild assumptions on the activation function. As Q(v) and P(v) are continuous functions on compact subsets of Rn, the theorem is adequate for the power flow use case under a suitable activation function. It should be noted that the construction of the ANN is long, and includes a combination of the theory as well as a trial and error process. Part of the implementation choices were taken according to a state solution using a neural network, where the guidelines for the construction of an ANN architecture for a distribution system are laid out as a preliminary work of the authors. Among them is the choice of the formula for the number of neurons in the hidden layer:

$$roundup [ \frac{\sqrt{1 + 8 \cdot l} - 1}{2} ] \qquad ( 9 )$$

where l is the number of neurons in the input layer. Also, the use of early stopping call-back, batch size, and the optimizer choice were used. The activation function of the hidden layer was chosen to be the well known logistic sigmoid function, as it has been proven as a suitable activation function for the universal approximation theorem:

$$f ( x ) = \frac{{e}^{x}}{{e}^{x} + 1} \qquad ( 10 )$$

In order to examine the choices of the various hyperparameters, an automated procedure was done via Talos. Talos is a python hyperparameter optimization library for Keras which allows to configure, perform and evaluate hyperparameter optimization experiments. With Talos, numerous experiments were conducted with different combinations of hyper-parameters options. The set of options was constructed by narrowing down relevant values according to the preliminary mentioned processes. The experiments were conducted on cluster A as depicted in FIG. 4, and the parameters' options are detailed in Table 5. More than 15,000 configurations have been tested, to cover a wide range of possibilities.

There was almost a definite division of the configurations performances according to the optimizer, from stochastic gradient descent (SGD) with the highest error, Root Mean Square Propagation (RMSprop) to adaptive moment estimation (Adam) with the lowest error. Indeed, Adam was chosen originally as the optimizer for the ANNs. The complete hierarchical architecture was tested with one of the best performing architectures from the experiment, and achieved similar results to the preliminary chosen architecture. Thus, the simulations provide a quantitative assessment for the hereby chosen design.

### Generation of Training and Testing Sets for the ANNs

Load-shape is a vector that is used to describe many input states of P-Q nodes in a power system. The load-shape is usually normalized and these multipliers are adjoint with the active and reactive power values as specified in the power system's definitions for attaining the values of various types of loads (such as domestic, industrial, and commercial). Since for the construction of a database, each input parameter should be assigned with numerous values in a long time series. And, in general, different loads have different values at each point in time, an assignment of different load-shapes to the active and reactive power of the P-Q buses is needed. The multiplication of the load-shapes with the active or reactive power definitions yields a vector which represents the behavior of the active or reactive power at that load throughout a whole year. There are different ways to synthetically generate multiple load-shapes out of a single load shape and a few attempts were introduced by adding noise distribution to the load-shape. In order to allocate each parameter (active/reactive power) at each load a different load-shape, a scaled version of the well-known u-law equation is used with different μ value for each power parameter. It is commonly used in communication applications to compress and expand (compand) signals over a given range. The governing equation is:

$$sgn ( x ) \frac{ln ( 1 + μ \vert x \vert )}{ln ( 1 + μ )} - 1 \leq x \leq 1 \qquad ( 11 )$$

where x is a four years-long load-shape vector and μ affects the non-linearity of the curve, thus defining the projected values. For various values for μ, though the load-shape is adjusted it preserves the original behavior of the load-shape, and it also maintains a similar operation region as the original shape due to a scaling operation that is added.

At least one example of the disclosure, rather than solving a set of nonlinear equations, approaches the problem using supervised ML. The method is based on an ANN, and solves the problem based on a training set composed of the results of many state solutions for the power systems produced by OpenDSS simulation software. It should be mentioned here that the choice of classical algorithm is not important, and can be changed. Since it is used only to generate the database and to verify the results, any suitable algorithm could be used. The time required to generate the data and the convergence time of the OpenDSS simulations are transparent to the ANN, since it is used only at the learning stage.

In order to have supervised learning for the neural networks, a dataset must be created. The dataset includes many inputs and outputs, some of them (80%) are used for training the ANNs, and some of them (20%) are used for testing and evaluating the ANNs performance for new unseen inputs. The inputs for each state of the system at a given point in time are the values of active and reactive power values at all loads and input correlation preserving parameters. The OpenDSS simulator calculates the solution numerically. As the power flow calculations of OpenDSS are based on the fixed point iterative numerical method, it sometimes does not converge to the correct result, as numerical methods are characterized with phenomenons of error accumulation and non-convergence. As a result, an outliers removal procedure was used, via a moving median filter with a window size of three samples. Then, the amplitude and phase of the voltage at each of the nodes and the relevant correlation preserving parameters are collected and used as the outputs for the training and evaluation corresponding to the different input states. After the training process of the ANNs is done, the PF solution will be achieved as the predication (output) of the ANNs, instead of a numerical calculation.

The power system is divided by the Infomap algorithm according to the distribution systems connectivity, as it yields from the admittance matrix generated by OpenDSS. A different database is generated for each of the clusters according to the algorithm's division, where each database is constructed from the parameters of the buses which belongs to each cluster.

### Simulation Results

In this section, the results of the simulations of two distribution system, IEEE-123 system and EPRI Ckt5 system, are presented. The ground truth data was generated in incorporation with OpenDSS's COM interface, and was divided into training and testing sets. The error metric used to evaluate the quality of the voltage amplitudes and phases predictions is the mean absolute error (MAE) and maximum absolute error (MAXAE):

$$MAE = \frac{{\sum }_{i = 1}^{N} \vert {y}_{i} - {\hat{y}}_{i} \vert}{n} \qquad ( 12 )$$

$$MAXAE = {max}_{i = 1 … N} \vert {y}_{i} - {\hat{y}}_{i} \vert \qquad ( 13 )$$

where N is the number of testing samples, yᵢ is the ground truth value according to the OpenDSS simulator results and ŷᵢ is the predicted value according to the ANN. The error metric for the active and reactive power at the head of the clusters is the relative MAE also known as Mean Absolute Percentage Error (MAPE). Namely, the absolute error is divided by the absolute value of the ground truth value, as the active and reactive power errors are relative to the ground truth value. Correspondingly, the relative MAXAE also known as Maximum Absolute Percentage Error (MAXAPE) is the maximum absolute error divided by the absolute value of the ground truth value. For each cluster, the errors were averaged over the power systems' buses for twenty consecutive runs with the same training and testing sets.

### Simulation Results for the IEEE-123 Distribution System

In this section, the results of the OpenDSS simulations, as well as the predictions of the ANNs for the IEEE-123 system, are presented.

IEEE-123 distribution system operates at a nominal voltage of 4.16 kV. The topology is shown in FIG. 4.

The simulation results for the ANN of cluster A shows a MAE of 0.021% for the voltage amplitudes, as shown in FIG. 7, where each section represents a different node in the cluster. Each point can represent a single sample from the testing set at a different point in time. The results are 0.0189% for phase A (the 0 degree phase), 0.01% for phase B (the 120 degree phase shift) and 0.012% for phase C (the −120 degree phase shift) MAE respectively, as shown in FIGS. 8-9 respectively. The relative MAE of the apparent power of the head node of cluster A is 0.407%. Similar results were obtained for clusters B, C and D, and are detailed in Table 1.

### Simulation Results for EPRI Ckt5 Distribution System

In this section, the results of the OpenDSS simulations, as well as the predictions of the ANNs for EPRI Ckt5 system, are presented.

EPRI Ckt5 operates at a nominal voltage of 12.47 kV, with a total of 16,310 kVA service transformers. The topology is shown in FIG. 5. In FIG. 5, red was associated with A, B was associated with blue, C was associated with fuchsia, D was associated with yellow, E was associated with green, F was associated with purple, and G was associated with olive.

The simulation results for the ANN of cluster A shows a MAE of 0.055% for the voltage amplitudes. The results are 0.069% for phase A (the 0 degree phase), 0.088% for phase B (the 120 degree phase shift) and 0.074% for phase C (the −120 degree phase shift) MAE respectively. The relative MAE of the apparent power of the head node of cluster A is 1.065%. Similar results were obtained for clusters B-G, and are detailed in Table 2.

TABLE 1
ANNs predictions errors of clusters
A, B, C, and D of IEEE-123 system.

| | voltage | voltage | voltage | voltage | S of |
|---|---|---|---|---|---|
| | amplitude | phase | phase | phase | cluster's |
| Error % | MAE | A MAE | B MAE | C MAE | PCC MAPE |
| Cluster A | 0.021 | 0.0189 | 0.01 | 0.012 | 0.407 |
| Cluster B | 0.011 | 0.01 | 0.006 | 0.005 | 0.359 |
| Cluster C | 0.014 | 0.013 | 0.002 | 0.009 | 0.381 |
| Cluster D | 0.011 | 0.01 | 0.005 | 0.006 | None |

The results of the MAXAE and MAXAPE are also detailed in Table 2, where clusters B, D, and E consists of nodes connected to all three phases, and clusters C, F, and G consists of nodes connected to phase B, B and C correspondingly. The results for the voltages of all clusters are consistently small, as well as just over 1% MAE for the apparent power at the PCC. The MAXAE results are less than 1.508% for all the clusters' voltages and less than 10% for the PCC apparent power MAXAPE. These results are common in the field, and are consistent with reported results of other works. It should be noted that the results in these works were obtained for a distribution systems with around 100 buses while in this paper similar errors were derived for a network of over 3,000 nodes.

TABLE 2
ANN's predictions errors of clusters A-G of EPRI Ckt5 system

| | voltage | | | | |
|---|---|---|---|---|---|
| | amplitude | voltage phase | voltage phase | voltage phase | S of cluster's |
| | MAE \| | A MAE \| | B MAE \| | C MAE \| | PCC MAPE \| |
| Error % | MAXAE | MAXAE | MAXAE | MAXAE | MAXAPE |
| Cluster A | 0.055 \| 0.239 | 0.069 \| 0.265 | 0.088 \| 0.339 | 0.074 \| 0.288 | 1.06 \| 5.91 |
| Cluster B | 0.046 \| 0.234 | 0.067 \| 0.295 | 0.079 \| 0.332 | 0.072 \| 0.316 | 1.081 \| 6.38 |
| Cluster C | 0.075 \| 0.311 | None | 0.091 \| 0.35 | None | 1.175 \| 8.356 |
| Cluster D | 0.246 \| 0.36 | 0.438 \| 1.357 | 0.48 \| 1.496 | 0.486 \| 1.508 | 1.76 \| 9.98 |
| Cluster E | 0.056 \| 0.239 | 0.079 \| 0.31 | 0.078 \| 0.301 | 0.082 \| 0.318 | 1.129 \| 6.962 |
| Cluster F | 0.054 \| 0.368 | None | 0.083 \| 0.572 | None | 1.06 \| 6.931 |
| Cluster G | 0.06 \| 0.249 | None | None | 0.084 \| 0.355 | 1.194 \| 7.574 |

### Computational Considerations

Among the advantages of the proposed hierarchical ANN tree structure, as a solution approach for the PF problem in distribution systems, is the reduced solution time in comparison to classic methods. This improvement is necessary due to the advancements in DSs and the desire to implement control of as-sets in real time applications (real time may mean in the range of minutes in practical cases).

The classical solution based on power flow solver (OpenDSS), as well as the ANNs were tested on a single computer for comparison. As an example, a computing device may have an 8th generation i7 1.8 GHz 8 GB RAM Intel processor, among others. It should be mentioned here that the importance is the comparison of the difference in the execution time and not the actual numbers. This is important since in industrial applications the global time can be significantly reduced by using more advanced and fast computers as well as parallel computing.

The computational time of an array tree structure (ATS) is:

$${t}_{ATS} = max ( {\sum }_{i = 1}^{{L}_{path - i}} max ( {t}_{j} ) j = 1 … {N}_{s} ) i = 1 … P \qquad ( 14 )$$

Where P is the number of paths, Lₚₐₜₕ₋ᵢ is the number of levels in path i and Nₛ is the number of clusters in each level, l, according to the InfoMap community detection algorithm's division.

### Computational Results for the IEEE-123 System

The time it took for each ANN to predict the testing set of IEEE-123 system is detailed in Table 3, averaged over 20 runs. As can be seen, the testing time of the array tree structure takes 0.022 seconds.

The solution time of the testing set for IEEE-123 via OpenDSS's python COM interface takes 1.3 seconds. Hence, the solution time via the array structure of ANNs is improved by a factor of 50 in comparison to the classical approach via the OpenDSS simulation software.

### Computational Results for EPRI Ckt5 System

The time it took for each ANN to predict the testing set of EPRI Ckt5 system is detailed in Table 4, averaged over twenty runs. According to equation fourteen, the testing time of the array tree structure takes 11.748 seconds. The solution time of the testing set for EPRI Ckt5 via OpenDSS's python COM interface takes 100.062 seconds. Hence, the solution time via the array structure of ANNs is improved by a magnitude of order in comparison to the classical approach via the OpenDSS simulation software.

TABLE 3
IEEE-123 ANNs' predictions times time

| | Testing time |
|---|---|
| Cluster name | [s] |
| Cluster A | 0.012 |
| Cluster B | 0.005 |
| Cluster C | 0.004 |
| Cluster D | 0.012 |

TABLE 4
Ckt5 ANNs' predictions times

| Cluster name | Testing time [s] |
|---|---|
| Cluster A | 7.005 |
| Cluster B | 4.743 |
| Cluster C | 1.841 |
| Cluster D | 2.367 |
| Cluster E | 3.474 |
| Cluster F | 0.388 |
| Cluster G | 0.246 |

Disclosed herein is a PF methodology using a hierarchical array of ANNs. Also disclosed herein are considerations for constructing the appropriate uniform ANN design. The methodology is demonstrated and simulated for the unbalanced IEEE-123 system as well as EPRI's large-scale Ckt5 system. The discussion of the various considerations and conditions that led to the uniform design of the ANN was also empirically shown to be at least locally optimal through a massive amount of experiments via the hyper-parameter optimization library Talos. The tree-like graph topological structure of distribution systems is utilized for a hierarchical distributed approach, which is laid out herein, including an appropriate division algorithm for the power system and the detailing of the required parameters for the description of each cluster and for the preservation of the electric information of the related clusters. The error performance of the results predicted by the trained ANNs tree array are assessed via the comparison to the results obtained from the numerical PF simulation software OpenDSS. The results support the method and theory disclosed herein. The performance of at least one example of the disclosure is shown to be as good as the PF problem's results of much more complicated architectures such as graph neural networks, without the redundant inherent complexity characterizing other deep networks designs. The computational complexity, which is a crucial factor in adopting the suggested ANN approach, is shown to reduce the time to get a result by at least magnitude of order: a factor of fifty for the IEEE-123 system and a magnitude of order of EPRI Ckt5. This is important since, in real time optimizations, it happens that PF must be performed numerous times for covering a large search space as a result of the large amount of controllable elements in modern smart grids. This improvement enables a result in sufficient time for making a control command. As DSs may suffer from frequent topology changes, more extensive learning may be required to tackle the generality ability of related AI implementations. The error performance are also very promising, with maximum MAE of 0.02% for the voltages and 0.4% MAPE for the injected powers at the CCP for the IEEE-123 system, and of maximum MAE, MAXAE of 0.048%, 1.5% for the voltages and 1.2%, 8.3% MAPE, MAXAPE correspondingly for the injected powers at the CCP for the Ckt5 system. An additional contribution of the hereby proposed approach is the inherent modularity of an array structure, which can be utilized, depending on the situation, by two approaches for events of topology changes. Due to the multilevel splitting results of the community detection algorithm Infomap, the DS can be divided with high granularity into many very small clusters. In this case, once a part of the system is disconnected, for high enough granularity, the modularity of the ANNs array would enable to adjust to most of the reconfiguration scenarios. Another approach disclosed herein is to select the clusters of the system according to a prior knowledge of the areas in which topology changes are more likely to occur. This way, the division and granularity will be specifically suited per system and can be updated periodically. The examples disclosed herein offer a basis for a proper operation capabilities of DSs. Such examples can therefore be used to solve the state of power systems, especially given the increasing rate of power grid transformation into smart grids, which may include many control, monitoring, and supervision technologies.

TABLE 5
ANN's hyper-parameters options for Talos automated experiments

| Hyper- | first | second | third | forth | fifth |
|---|---|---|---|---|---|
| parameter | option | option | option | option | option |
| number of | eq. 9 | eq. 9 | eq. 9 | eq. 9 | eq. 9 |
| neurons in | | divided | divided | multiplied | multiplied |
| the hidden | | by 2 | by 4 | by 2 | by 4 |
| layer | | | | | |
| number of | 0 | 1 | 2 | 3 | |
| hidden layers | | | | | |
| batch size | 32 | 64 | 128 | 256 | |
| epochs | 50 | 100 | 150 | 200 | |
| optimizer | SGD | Adam | RMSprop | | |
| activation | linear | relu | tanh | sigmoid | |
| function of | | | | | |
| the in-put | | | | | |
| layer | | | | | |
| activation | linear | relu | tanh | sigmoid | |
| function of | | | | | |
| the in-put | | | | | |
| layer | | | | | |
| activation | linear | relu | tanh | sigmoid | |
| function of | | | | | |
| the in-put | | | | | |
| layer | | | | | |

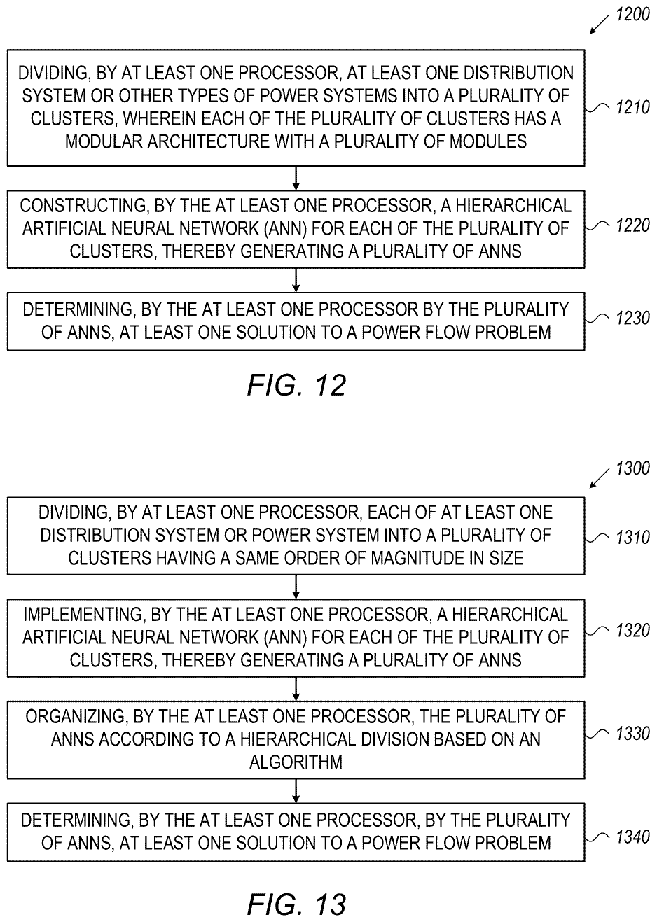

FIG. 12 shows a method 1200 of solving a power flow problem in at least one distribution system or other types of power systems having various sizes, according to an example of the instant disclosure. Although the example method 1200 depicts a particular sequence of operations, the sequence may be altered without departing from the scope of the present disclosure. For example, some of the operations depicted may be performed in parallel or in a different sequence that does not materially affect the function of the method 1200. In other examples, different components of an example device or system that implements the method 1200 may perform functions at substantially the same time or in a specific sequence.

According to some examples, the method 1200 includes dividing, by at least one processor, the at least one distribution system or other types of power systems having various sizes, into a plurality of clusters, wherein each of the plurality of clusters has a modular architecture with a plurality of modules at block 1210. As an example, the at least one distribution system or other types of power systems having various sizes, can be selected from the group consisting of: an IEEE-123 system, an EPRI Ckt5 system, a distribution and/or transmission system, and combinations thereof.

According to some examples, the method 1200 includes constructing, by the at least one processor, a hierarchical artificial neural network (ANN) for each of the plurality of clusters, thereby generating a plurality of ANNs at block 1220.

According to some examples, the method 1200 includes determining, by the at least one processor by the plurality of ANNs, at least one solution to a power flow problem for (i) each of the plurality of ANNs, and (2) the hierarchical ANN as a whole at block 1230. As an example, each of the plurality of ANNs can be organized hierarchically such that data from at least one lower-level layer is fed into at least one upper layer in accordance with an electric correlation between at least one cluster in the plurality of clusters.

FIG. 13 shows a method 1300 of solving a power flow problem in at least one distribution system or power system according to an example of the instant disclosure. Although the example method 1300 depicts a particular sequence of operations, the sequence may be altered without departing from the scope of the present disclosure. For example, some of the operations depicted may be performed in parallel or in a different sequence that does not materially affect the function of the method 1300. In other examples, different components of an example device or system that implements the method 1300 may perform functions at substantially the same time or in a specific sequence.

According to some examples, the method 1300 includes dividing, by at least one processor, each of the at least one distribution system or power system into a plurality of clusters having a same order of magnitude or a different order of magnitude in size at block 1310.

According to some examples, the method 1300 includes implementing, by the at least one processor, a hierarchical artificial neural network (ANN) for each of the plurality of clusters, thereby generating a plurality of ANNs at block 1320.

According to some examples, the method 1300 includes organizing, by the at least one processor, the plurality of ANNs according to a hierarchical division based on an algorithm at block 1330. In one example, the algorithm is a community detection algorithm based on a hierarchical version of a map equation.

According to some examples, the method 1300 includes determining, by the at least one processor by the plurality of ANNs, at least one solution to a power flow problem for (i) each of the plurality of ANNs, and (2) an entire hierarchical structure of the plurality of ANNs at block 1340.

As an example, the plurality of ANNs can be configured to predict voltage amplitudes, phases, apparent powers, and correlation preserving parameters of the at least one power system. In addition, as an example, each of the plurality of ANNs can be organized hierarchically such that data from at least one lower-level layer is fed into at least one upper layer in accordance with an electric correlation between at least one cluster in the plurality of clusters.

As an example, each of the plurality of ANNs is either a multi-layer perceptron regressor (MLPR) or another neural network having a single hidden layer.

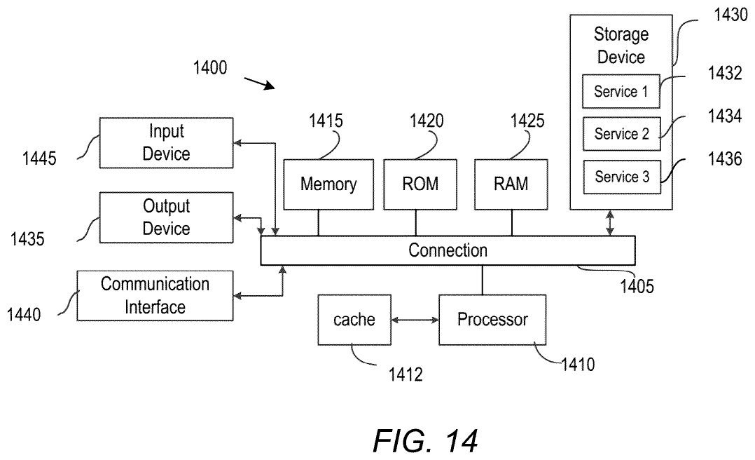

FIG. 14 shows an example of computing system 1400, which can be, for example, a computing device, or any component thereof in which the components of the system are in communication with each other using connection 1405. Connection 1405 can be a physical connection via a bus, or a direct connection into processor 1410, such as in a chipset architecture. Connection 1405 can also be a virtual connection, networked connection, or logical connection.

In some embodiments, computing system 1400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1400 includes at least one processing unit (CPU or processor) 1410 and connection 1405 that couples various system components including system memory 1415, such as read-only memory (ROM) 1420 and random access memory (RAM) 1425 to processor 1410. Computing system 1400 can include a cache of high-speed memory 1412 connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms known to those of skill in the art. In some instances, multimodal systems can enable a user to provide multiple types of input/output to communicate with computing system 1400. Computing system 1400 can include communications interface 1440, which can generally govern and manage the user input and system output. There is no restriction on operating on any particular hardware arrangement, and therefore the basic features here may easily be substituted for improved hardware or firmware arrangements as they are developed.

Storage device 1430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1430 can include software services, servers, services, etc., that when the code that defines such software is executed by the processor 1410, it causes the system to perform a function. In some embodiments, a hardware service that performs a particular function can include the software component stored in a computer-readable medium in connection with the necessary hardware components, such as processor 1410, connection 1405, output device 1035, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources provide the functions described in these disclosures.

### Illustrative Examples of the Disclosure Include:

Aspect 1: A method for solving a power flow problem in at least one distribution system other types of power systems having various sizes, the method comprising dividing, by at least one processor, the at least one distribution system or other types of power systems having various sizes into a plurality of clusters, wherein each of the plurality of clusters has a modular architecture with a plurality of modules, constructing, by the at least one processor, a hierarchical artificial neural network (ANN) for each of the plurality of clusters, thereby generating a plurality of ANNs, and determining, by the at least one processor by the plurality of ANNs, at least one solution to a power flow problem for (i) each of the plurality of ANNs, and (2) the hierarchical ANN as a whole, wherein each of the plurality of ANNs is organized hierarchically such that data from at least one lower-level layer is fed into at least one upper layer in accordance with an electric correlation between at least one cluster in the plurality of clusters.

Aspect 2: The method of Aspect 1, wherein the at least one distribution system or other types of power systems having various sizes is selected from the group consisting of: an IEEE-123 system, an EPRI Ckt5 system, a distribution and/or transmission system, and combinations thereof.

Aspect 3: A method for solving a power flow problem in at least one power system, the method comprising dividing, by at least one processor, each of the at least one distribution system or power system into a plurality of clusters, implementing, by the at least one processor, a hierarchical artificial neural network (ANN) for each of the plurality of clusters, thereby generating a plurality of ANNs, organizing, by the at least one processor, the plurality of ANNs according to a hierarchical division based on an algorithm, and determining, by the at least one processor by the plurality of ANNs, at least one solution to a power flow problem for (i) each of the plurality of ANNs, and (2) an entire hierarchical structure of the plurality of ANNs, wherein the plurality of ANNs are configured to predict voltage amplitudes, phases, apparent powers, and correlation preserving parameters of the at least one distribution or power system, and wherein each of the plurality of ANNs is organized hierarchically such that data from at least one lower-level layer is fed into at least one upper layer in accordance with an electric correlation between at least one cluster in the plurality of clusters.

Aspect 4: The method of Aspect 3, wherein the algorithm is a community detection algorithm or other graph partitioning algorithm.

Aspect 5: The method of Aspects 3 and 4, wherein the community detection algorithm is based on a hierarchical version of a map equation.

Aspect 6: The method of Aspects 3 to 5, wherein each of the plurality of ANNs is either a multi-layer perceptron regressor (MLPR) or another neural network.

Aspect 7: The method of Aspects 3 to 6, wherein the another neural network has a single hidden layer.

Aspect 8: The method of Aspects 3 to 7, wherein the plurality of clusters have a same order of magnitude in size.

Aspect 9: A system for solving a power flow problem in at least one distribution system or other types of power systems having various sizes, the system comprising: a memory storing computer-readable instructions and at least one processor to execute the instructions to divide the at least one distribution system or other types of power systems having various sizes into a plurality of clusters, wherein each of the plurality of clusters has a modular architecture with a plurality of modules, construct a hierarchical artificial neural network (ANN) for each of the plurality of clusters, thereby generating a plurality of ANNs, and determine at least one solution to a power flow problem for (i) each of the plurality of ANNs, and (2) the hierarchical ANN as a whole, wherein each of the plurality of ANNs is organized hierarchically such that data from at least one lower-level layer is fed into at least one upper layer in accordance with an electric correlation between at least one cluster in the plurality of clusters.

Aspect 10: The system of Aspect 9, wherein the at least one distribution system is selected from the group consisting of: an IEEE-123 system, an EPRI Ckt5 system, a distribution and/or transmission system, and combinations thereof.

Aspect 11: A system for solving a power flow problem in at least one distribution system or power system, the system comprising a memory storing computer-readable instructions and at least one processor to execute the instructions to divide each of the at least one distribution or power system into a plurality of clusters, implement a hierarchical artificial neural network (ANN) for each of the plurality of clusters, thereby generating a plurality of ANNs, organize the plurality of ANNs according to a hierarchical division based on an algorithm, and determine by the plurality of ANNs at least one solution to a power flow problem for (i) each of the plurality of ANNs, and (2) an entire hierarchical structure of the plurality of ANNs, wherein the plurality of ANNs are configured to predict voltage amplitudes, phases, apparent powers, and correlation preserving parameters of the at least one distribution or power system, and wherein each of the plurality of ANNs is organized hierarchically such that data from at least one lower-level layer is fed into at least one upper layer in accordance with an electric correlation between at least one cluster in the plurality of clusters.

Aspect 12: The system of Aspect 11, wherein the algorithm is a community detection algorithm or other graph partitioning algorithm.

Aspect 13: The system of Aspects 11 and 12, wherein the community detection algorithm is based on a hierarchical version of a map equation.

Aspect 14: The system of Aspects 11 to 13, wherein each of the plurality of ANNs is either a multi-layer perceptron regressor (MLPR) or another neural network.

Aspect 15: The system of Aspects 11 to 14, wherein the another neural network has a single hidden layer.

Aspect 16: The system of Aspects 11 to 15, wherein the plurality of clusters have a same order of magnitude in size.

Aspect 17: A non-transitory computer-readable storage medium, having instructions stored thereon that, when executed by at least one computing device cause the at least one computing device to perform operations for solving a power flow problem in at least one distribution system or other types of power systems having various sizes, the operations comprising dividing the at least one distribution system or other types of power systems having various sizes into a plurality of clusters, wherein each of the plurality of clusters has a modular architecture with a plurality of modules, constructing a hierarchical artificial neural network (ANN) for each of the plurality of clusters, thereby generating a plurality of ANNs, and determining by the plurality of ANNs at least one solution to a power flow problem for (i) each of the plurality of ANNs, and (2) the hierarchical ANN as a whole, wherein each of the plurality of ANNs is organized hierarchically such that data from at least one lower-level layer is fed into at least one upper layer in accordance with an electric correlation between at least one cluster in the plurality of clusters.

Aspect 18: The non-transitory computer-readable storage medium of Aspect 17, wherein the at least one distribution system is selected from the group consisting of: an IEEE-123 system, an EPRI Ckt5 system, a distribution and/or transmission system, and combinations thereof.

Aspect 19: A non-transitory computer-readable storage medium, having instructions stored thereon that, when executed by at least one computing device cause the at least one computing device to perform operations for solving a power flow problem in at least one distribution or power system, the operations comprising dividing each of the at least one distribution or power system into a plurality of clusters, implementing a hierarchical artificial neural network (ANN) for each of the plurality of clusters, thereby generating a plurality of ANNs, organizing the plurality of ANNs according to a hierarchical division based on an algorithm, and determining by the plurality of ANNs at least one solution to a power flow problem for (i) each of the plurality of ANNs, and (2) an entire hierarchical structure of the plurality of ANNs, wherein the plurality of ANNs are configured to predict voltage amplitudes, phases, apparent powers, and correlation preserving parameters of the at least one distribution or power system, and wherein each of the plurality of ANNs is organized hierarchically such that data from at least one lower-level layer is fed into at least one upper layer in accordance with an electric correlation between at least one cluster in the plurality of clusters.

Aspect 20: The non-transitory computer-readable storage medium of Aspect 19, wherein the algorithm is a community detection algorithm or other graph partitioning algorithm.

Aspect 21: The non-transitory computer-readable storage medium of Aspects 19 and 20, wherein the community detection algorithm is based on a hierarchical version of a map equation.

Aspect 22: The non-transitory computer-readable storage medium of Aspects 19 to 21, wherein each of the plurality of ANNs is either a multi-layer perceptron regressor (MLPR) or another neural network.

Aspect 23: The non-transitory computer-readable storage medium of Aspects 19 to 22, wherein the another neural network has a single hidden layer.

Aspect 24: The non-transitory computer-readable storage medium of Aspects 19 to 23, wherein the plurality of clusters have a same order of magnitude in size.

1. A method for solving a power flow problem in at least one distribution system or other types of power systems having various sizes, the method comprising:
dividing, by at least one processor, the at least one distribution system or other types of power systems having various sizes into a plurality of clusters, wherein each of the plurality of clusters has a modular architecture with a plurality of modules;
constructing, by the at least one processor, a hierarchical artificial neural network (ANN) for each of the plurality of clusters, thereby generating a plurality of ANNs; and
determining, by the at least one processor by the plurality of ANNs, at least one solution to a power flow problem for (i) each of the plurality of ANNs, and (2) the hierarchical ANN as a whole,
wherein each of the plurality of ANNs is organized hierarchically such that data from at least one lower-level layer is fed into at least one upper layer in accordance with an electric correlation between at least one cluster in the plurality of clusters.

2. The method of claim 1, wherein the at least one distribution system or other types of power systems having various sizes is selected from the group consisting of: an IEEE-123 system, an EPRI Ckt5 system, a distribution and/or transmission system, and combinations thereof.

3. The method of claim 1,
wherein the hierarchical organization is based on an algorithm.

4. The method of claim 3, wherein the algorithm is a community detection algorithm or other graph partitioning algorithm.

5. The method of claim 4, wherein the community detection algorithm is based on a hierarchical version of a map equation.

6. The method of claim 3, wherein each of the plurality of ANNs is either a multi-layer perceptron regressor (MLPR) or another neural network.

7. The method of claim 6, wherein the another neural network has a single hidden layer.

8. The method of claim 3, wherein the plurality of clusters have a same order of magnitude in size.

9. (canceled)

10. (canceled)

11. A system for solving a power flow problem in at least one distribution system or power system, the system comprising:
a memory storing computer-readable instructions; and
at least one processor to execute the instructions to:
divide each of the at least one distribution or power system into a plurality of clusters;
implement a hierarchical artificial neural network (ANN) for each of the plurality of clusters, thereby generating a plurality of ANNs;
organize the plurality of ANNs according to a hierarchical division based on an algorithm; and
determine by the plurality of ANNs at least one solution to a power flow problem for (i) each of the plurality of ANNs, and (2) an entire hierarchical structure of the plurality of ANNs,
wherein the plurality of ANNs are configured to predict voltage amplitudes, phases, apparent powers, and correlation preserving parameters of the at least one distribution or power system, and
wherein each of the plurality of ANNs is organized hierarchically such that data from at least one lower-level layer is fed into at least one upper layer in accordance with an electric correlation between at least one cluster in the plurality of clusters.

12. The system of claim 11, wherein the at least one distribution system is selected from the group consisting of: an IEEE-123 system, an EPRI Ckt5 system, a distribution and/or transmission system, and combinations thereof.

13. The system of claim 11, wherein the algorithm is a community detection algorithm is-based on a hierarchical version of a map equation or other graph partitioning algorithm.

14. The system of claim 11, wherein each of the plurality of ANNs is either a multi-layer perceptron regressor (MLPR) or another neural network.

15. The system of claim 14, wherein the another neural network has a single hidden layer.

16. The system of claim 11, wherein the plurality of clusters have a same order of magnitude in size.

17. A non-transitory computer-readable storage medium, having instructions stored thereon that, when executed by at least one computing device cause the at least one computing device to perform operations for solving a power flow problem in at least one distribution system or other types of power systems having various sizes, the operations comprising:
dividing the at least one distribution system or other types of power systems having various sizes into a plurality of clusters, wherein each of the plurality of clusters has a modular architecture with a plurality of modules;
constructing a hierarchical artificial neural network (ANN) for each of the plurality of clusters, thereby generating a plurality of ANNs; and
determining by the plurality of ANNs at least one solution to a power flow problem for (i) each of the plurality of ANNs, and (2) the hierarchical ANN as a whole,
wherein each of the plurality of ANNs is organized hierarchically such that data from at least one lower-level layer is fed into at least one upper layer in accordance with an electric correlation between at least one cluster in the plurality of clusters.

18. The non-transitory computer-readable storage medium of claim 17, wherein the at least one distribution system is selected from the group consisting of: an IEEE-123 system, an EPRI Ckt5 system, a distribution and/or transmission system, and combinations thereof.

19. The non-transitory computer-readable storage medium of claim 17,
wherein the plurality of ANNs are configured to predict voltage amplitudes, phases, apparent powers, and correlation preserving parameters of the at least one distribution or power system.

20. The non-transitory computer-readable storage medium of claim 17, wherein the hierarchical organization is based on an algorithm, and wherein the algorithm is a community detection algorithm based on a hierarchical version of a map equation or other graph partitioning algorithm.

21. (canceled)

22. The non-transitory computer-readable storage medium of claim 17, wherein each of the plurality of ANNs is either a multi-layer perceptron regressor (MLPR) or another neural network, the another neural network having a single hidden layer.

23. (canceled)

24. The non-transitory computer-readable storage medium of claim 17, wherein the plurality of clusters have a same order of magnitude in size.
